(19) United States
(12) Patent Application Publication
(10) Pub. No.: US 2026/0073396 A1
(43) Pub. Date: Mar. 12, 2026

(54) MULTI-STAGE MOBILE DEPOSIT CHECK VERIFICATION AND FRAUD PREVENTION SYSTEM

(71) Applicant: Chime Financial, Inc., San Francisco, CA (US)

(72) Inventors: Alexander Ivan Stone, Chicago, IL (US); Mitchell Ginsburg, Walnut Creek, CA (US); Alexandre Benoit, New York, NY (US); Samarjith Jawaharlal Sathyanarayan, Buffalo Grove, IL (US)

(21) Appl. No.: 18/827,355

(22) Filed: Sep. 6, 2024

(51) Int. Cl. G06Q 20/40; G06Q 20/04

(52) U.S. Cl. CPC G06Q 20/4016; G06Q 20/042

(57) ABSTRACT

The present disclosure relates to systems, non-transitory computer-readable media, and methods that utilize a multi-stage image processing approach to extract and analyze data from multiple check images at various stages of depositing mobile deposit checks. For instance, the disclosed systems can receive and process a first mobile check image of the front of a mobile deposit check to make a preliminary acceptance determination from extracted check image data. The disclosed systems further request, as a separate step from the first mobile check image, a second mobile check image of the back of the mobile deposit check. Based on the initial acceptance probability, the multi-step image processing system determines whether to require a restrictive endorsement in the second mobile check image and can extract and analyze data from the second mobile check image to determine a final acceptance probability.

### BACKGROUND

As online transactions have increased in recent years, network-transaction-security systems have increasingly used computational models to detect and protect against cyber fraud, cyber theft, or other network security threats that compromise encrypted or otherwise sensitive information. For example, as network security risks have increased, existing network-transaction-security systems have employed more sophisticated computing models to detect security risks affecting transactions, account balances, personal identity information, and other information over computer networks that use computing device applications. In the domain of mobile check deposit network transactions, for instance, these security risks can take the form of fake check images, repeat mobile deposit attempts for a singular check via different account systems (i.e., duplicate presentment), synthetic network accounts, altered or forged check data, etc. Exacerbating these issues, hackers have become more sophisticated to the point of mimicking characteristics of authentic network transactions detected or flagged by existing computational models.

In view of the foregoing complexities, some existing network-transaction-security systems are insecure. For example, conventional network-transaction-security systems often misidentify invalid checks or fail to detect duplicate presentment of check images. Such inaccuracy often leads to insecurity due to incorrectly processed mobile check data that results from the conventional paradigm of single-stage check image processing. Indeed, existing network-transaction-security systems generally receive and process mobile check images in a single stage, where both a front image and a back image of a check are received and processed together. This single-stage processing congruently results in a single authentication step and is susceptible to sophisticated fraud tactics and duplicate presentment.

In addition to the inaccuracies that undermine the security of network-transaction-security systems, existing systems also exhibit inefficiencies in excessive computer resource utilization. For example, some prior systems waste computer processing and network bandwidth by processing multiple images—of the front and the back of mobile deposit checks—together. Specifically, by requiring a complete set of multiple images for data processing, conventional systems process large amounts of mobile check data that can cause slowdowns and create bottlenecks that unnecessarily delay the verification and processing of mobile deposit checks. To elaborate, processors implemented by conventional systems often remain idle during the upload process of both check images, waiting for a second image even after the first image is uploaded. Thus, conventional systems are doubly inefficient, wasting computation time with idle processes during multi-image upload and further overburdening computer resource once upload is complete by processing the multiple uploaded images at once.

These, along with additional problems and issues, exist with conventional networking systems.

### SUMMARY

This disclosure describes one or more embodiments of methods, non-transitory computer-readable media, and systems that can solve the foregoing problems in addition to providing other benefits. Particularly, the disclosed systems can improve computational security, efficiency, and flexibility by utilizing a multi-step image processing system to bifurcate the process of extracting, analyzing, and verifying data from a mobile deposit check. For example, the disclosed systems receive and process a first mobile check image of the front of a mobile deposit check to make a preliminary acceptance determination from extracted check image data. The disclosed systems further request, as a separate step from the first mobile check image, a second mobile check image of the back of the mobile deposit check. Based on the initial acceptance probability, the multi-step image processing system determines whether to require a restrictive endorsement in the second mobile check image and whether to extract and analyze data from the second mobile check image to determine a final acceptance probability.

### BRIEF DESCRIPTION OF THE DRAWINGS

The detailed description refers to the drawings briefly described below.

FIG. 1 illustrates a block diagram of an environment for implementing an inter-network facilitation system and a multi-step image processing system in accordance with one or more embodiments.

FIG. 2 illustrates an example overview of processing a mobile deposit check based on receiving a first image and a second image in accordance with one or more embodiments.

FIG. 3 illustrates an example diagram for extracting and providing mobile deposit check image data to a third party for verification in accordance with one or more embodiments.

FIG. 4 illustrates an example overview of determining an acceptance probability utilizing a prediction model in accordance with one or more embodiments.

FIG. 5 illustrates an example diagram for relating various thresholds to an acceptance probability in accordance with one or more embodiments.

FIG. 6 illustrates an example diagram for generating a final acceptance probability in accordance with one or more embodiments.

FIG. 7 illustrates an example diagram for determining whether to require a restrictive endorsement in accordance with one or more embodiments

FIG. 8 illustrates an example series of acts for determining a final acceptance probability using a multi-step image processing approach for a mobile deposit check in accordance with one or more embodiments.

FIG. 9 illustrates a block diagram of a computing device for implementing one or more embodiments of the present disclosure.

FIG. 10 illustrates an example environment for an inter-network facilitation system in accordance with one or more embodiments.

### DETAILED DESCRIPTION

This disclosure describes a multi-step image processing system that improves processing of financial instruments such as mobile deposit checks through extracting and analyzing data from images at multiple stages. In some situations, the multi-step image processing system processes mobile deposits from client devices through extracting and analyzing check image data. To improve this process over implementations of prior systems, the multi-step image processing system implements a two-stage or two-step image processing approach. For example, the multi-step image processing system can receive and process a first mobile check image depicting the front of a mobile deposit check to determine an initial acceptance probability. Indeed, the multi-step image processing system determines the initial acceptance probability from the first mobile check image alone, without receiving or analyzing data from the back of the mobile deposit check. Upon determining the initial acceptance probability, the multi-step image processing system can request a second mobile check image depicting the back of the mobile deposit check and can process the second mobile check image (in conjunction with the analysis of the first image) to determine a final acceptance probability. Depending on the initial acceptance probability (e.g., indicating how likely the mobile deposit check is to be valid or invalid for one reason or another), the multi-step image processing system can further request or require a restrictive endorsement to accompany the second check image.

As just mentioned, in some embodiments, the multi-step image processing system receives and processes a first mobile check image from a client device. As part of processing the first mobile check image, the multi-step image processing system extracts check image data from the first mobile check image and feeds or sends the extracted check image data to an image data verification system. In addition, the multi-step image processing system receives verified check data (e.g., data in the form of, or for generating, machine learning features processible by an acceptance probability machine learning model) from the image data verification system, such as indications of financial institution status (e.g., whether the bank indicated in the image is valid), check number validity, and signature validity. In some cases, the multi-step image processing system generates all or some of the verified check data, such as validating a signature by cross-referencing with stored signatures for a user account.

In some embodiments, the multi-step image processing system further generates or determines an initial acceptance probability from the verified check data (and/or other check image data). To elaborate, the multi-step image processing system uses an acceptance probability machine learning model to process verified check data (or features extracted from verified check data) and/or other check image data to generate an initial acceptance probability that indicates a probability or likelihood of accepting the mobile deposit check. As part of this process, the acceptance probability machine learning model can cross-reference the verified check data and/or the check image data with known patterns and databases to generate a probability that the mobile deposit check is acceptable (or unacceptable/fraudulent).

In some cases, the multi-step image processing system determines whether to accept the mobile deposit check based on the initial acceptance probability. Indeed, the multi-step image processing system can compare the initial acceptance probability to an acceptance threshold. Thus, if the multi-step image processing system determines that the initial acceptance probability is below the acceptance threshold, the multi-step image processing system rejects the mobile deposit check (while still continuing with the frontend interface flow for uniformity in user experience). Alternatively, if the acceptance probability satisfies the acceptance threshold, the multi-step image processing system (preliminarily) determines to accept the mobile deposit check. In some embodiments, if the initial acceptance probability satisfies the acceptance threshold but does not satisfy some higher threshold for outright acceptance, the multi-step image processing system determines to request or require a restrictive endorsement for the mobile deposit check (e.g., included as part of a second mobile check image for the back of the mobile deposit check).

In some embodiments, the multi-step image processing system extracts check image data from the second mobile check image to determine a final acceptance probability. For instance, the multi-step image processing system extracts data such as a signature from the second mobile check image. In some cases, the multi-step image processing system also extracts and verifies (e.g., via the image data verification system) restrictive endorsement data from the second mobile check image. In some embodiments, the multi-step image processing system further feeds the extracted/verified check image data from the second mobile check image to a mobile deposit check prediction model to determine a final acceptance probability.

As suggested above, embodiments of the disclosed multi-step mobile deposit check verification system provide several improvements or advantages over conventional network-transaction-security systems. For example, the multi-step image processing system can improve security over prior systems. Unlike prior systems that are prone to misidentifying invalid checks and/or duplicate presentment due to single-stage image processing, the multi-step image processing system implements a multi-stage check image analysis process that facilitates more robust data security checks. For example, splitting the extraction and analysis of check image date into two stages allows the multi-step image processing system to prioritize security without compromising speed. As a result, the multi-step system can conduct more rigorous security protocols that are prohibitively slow (and thus unused) in prior systems, such as verifying the alignment and consistency of printed text, examining micro-printing or watermark features, and running advanced machine learning models to detect anomalies. Indeed, the multi-step image processing system can perform these rigorous checks on a first mobile check image while simultaneously providing a frontend user experience to request upload of a second mobile check image. By splitting the image processing into two stages, the multi-step image processing system is able to perform better security protocols to prevent faulty or fraudulent data without slowing down or encumbering the user experience (which may otherwise be frozen or non-interactive for excessing time periods for data processing if such processes were implemented in single-stage systems).

In addition to improving computational data security, the multi-step image processing system also improves efficiency by reducing computer resource utilization compared to prior systems. For example, by initiating data extraction and analysis for only a front image, the multi-step image processing system avoids bottlenecks and delays caused by the computational expense of receiving and processing multiple images in a single stage as in prior systems. This staggered approach enables the multi-step image processing system to begin verification and fraud detection processes earlier, thereby increasing overall speed and reducing processor downtime. Indeed, by uploading images in stages, the multi-step image processing system can more quickly receive uploads (e.g., one image is faster to upload than multiple together) and can process an uploaded image to determine an initial acceptance probability while simultaneously providing frontend user interfaces for uploading the second image (thus reducing downtime or idle interfaces frozen during background processing that are more prevalent in prior systems). Consequently, the multi-step image processing system provides immediate feedback on an acceptability decision for a mobile deposit check image upon processing a front image and while receiving and analyzing a back image, thereby reducing the likelihood of multi-image resubmissions. Indeed, the multi-step image processing system reduces resubmissions of duplicative data that include multiple images (e.g., a resubmission would more likely include only a single image for the initial probability determination), thus reducing the computational burden of storing and processing resubmitted images.

As a contributing factor to its enhanced efficiency, the multi-step image processing system also offers improved flexibility over prior systems. By verifying, analyzing, and processing mobile check data from the front image, the multi-step image processing system can make more informed decisions about whether to proceed with analyzing the back image. For example, the multi-step image processing system avoids wasting time and computer resources by refraining from needlessly extracting and analyzing back image data when a rejection can be determined from front image data alone. Thus, by flexibly adapting the processing of second-image data based on the analysis for first-image data, the multi-step image processing system preserves computational resources that might otherwise be wasted in processing multiple images in cases where a rejection can be determined from the first image (and without the second image).

As indicated by the foregoing discussion, the present disclosure utilizes a variety of terms to describe features and advantages of the multi-step image processing system. For example, as used herein, the term “inter-network facilitation system” refers to a system that, via the multi-step image processing system, facilitates digital communications across different computing systems over one or more networks. For example, an inter-network facilitation system manages digital accounts, such as credit accounts, bank accounts, transaction card accounts, and secured accounts in addition to financial information, such as funds transfers, withdrawals, deposits, and loans for one or more user profiles registered within the inter-network facilitation system. In some cases, the inter-network facilitation system is a centralized network system that includes multiple network components for facilitating access to online digital accounts via a central network location. Indeed, the inter-network facilitation system can link accounts from different network-based financial institutions to provide information regarding, and management tools for, the different accounts.

As mentioned, in some embodiments, the multi-step image processing system receives and analyzes mobile check images for mobile deposit checks. As used herein, a “mobile check image” (or simply check image) refers to digital image or some other digitized form of a check or other financial instrument that is digitally processed and deposited into a bank account using a mobile device, such as a smartphone or tablet. For example, a first mobile check image can include or refer to a digital image version of a first (e.g., front) side of a mobile deposit check, including pixels depicting information such as a payer name, a payee name, an amount, a date of issuance, a routing number, an account number, and a signature line. Relatedly, a second mobile check image can include or refer to a digital image version of a second (e.g., back) side of a mobile deposit check, including pixels depicting an endorsement signature and/or a restrictive endorsement.

Along these lines, a “restrictive endorsement” refers to a specific instruction written on the back of a mobile deposit check that limits or defines how the check can be processed. To elaborate, a restrictive endorsement often includes a signature along with additional words such as "For Mobile Deposit Only," or “For Deposit only at Chime” that limit the number of banks (or which particular banks) that may deposit the check into the specified account and prevents further negotiation or cashing of the check. In some embodiments, a restrictive endorsement is only required if an initial acceptance probability satisfies one or more thresholds and fails one or more other thresholds.

To elaborate, the term “acceptance probability” refers to a likelihood or a probability that the multi-step image processing system will accept a mobile deposit check based on an analysis of check image data and/or verified check data extracted from a first mobile check image. For example, the multi-step image processing system utilizes an acceptance probability machine learning model to determine the initial acceptance probability by analyzing check image data extracted from the first mobile check image utilizing a mobile check data extraction model. Similarly, the multi-step image processing system can determine a final acceptance probability based on a first mobile check image (or data extracted therefrom) and a second mobile check image (or data extracted therefrom). Additional detail regarding the various acceptance probabilities is provided below with reference to the figures.

Relatedly, as used herein, the term “fraud probability” refers to a likelihood or a probability that the multi-step image processing system will identify a mobile deposit check as fraudulent based on an analysis of check image data. For example, the multi-step image processing system utilizes a fraud prediction model to determine the fraud probability by analyzing check image data extracted from the first mobile check image using a mobile check data extraction model.

Furthermore, the term “check image data” refers to data or information extracted from a mobile check image. For example, mobile check data can include the check number, the payer name, the payee name, the amount, the date of issuance, the bank routing number, and the account number. Check image data may include any other visible features like a bank logo, a check type (e.g., a treasury check, a standard check, or a traveler’s check), watermarks, endorsement data, a signature, and other security features printed on a check. In some cases, check image data includes “restrictive endorsement data” that refers to data or information, such as a signature, a restrictive endorsement description, and/or microprint signatures defining a restrictive endorsement in a mobile check image. In these or other cases, check image data includes or refers to “verified check data” (or “verified check image data”) that is data verified by an image data verification system, such as features extracted from check image data and which is processible by a machine learning model to generate an acceptance probability. In some embodiments, the multi-step image processing system extracts check image data utilizing a mobile check data extraction model.

Relatedly, the term “image data verification system” refers to a system designed to verify and validate data extracted from images of mobile deposit checks. In some cases, an image data verification system refers to a trained machine-learning model that generates a verification prediction for one or more mobile check deposits. For example, an image data verification system can include a random forest model, a series of gradient boosted decision trees (e.g., XGBoost algorithm), a multilayer perceptron, a linear regression, a support vector machine, a deep tabular learning architecture, a deep learning transformer (e.g., self-attention-based-tabular transformer), or a logistic regression. In other embodiments, an image data verification system includes a neural network.

Additionally, as used herein, the term “mobile check data extraction model” refers to a computational algorithm, machine learning model, or neural network that extracts relevant data from images of mobile deposit checks. For example, the mobile check data extraction model may extract check image data. Furthermore, the mobile check data extraction model may extract restrictive endorsement data. In some cases, the mobile check data extraction model utilizes OCR, image processing, and pattern recognition technology to recognize, extract, and provide either one or both of check image data and restrictive endorsement data to the acceptance probability machine learning model.

Furthermore, as used herein, the term “acceptance probability machine learning model” refers to a computational algorithm, machine learning model, or neural network that analyzes data extracted from images of mobile deposit checks to generate an acceptance probability. For example, the acceptance probability machine learning model analyzes mobile check data and restrictive endorsement data to determine an initial acceptance probability and a final acceptance probability according to its internal, learned parameters. The acceptance probability machine learning model can use techniques such as anomaly detection, pattern recognition, and historical data analysis as part of generating an acceptance probability.

In addition, as used herein, the term “fraud prediction model” refers to a computational algorithm, machine learning model, or neural network designed to identify fraudulent data in mobile deposit checks. For example, the fraud prediction model analyzes check image data extracted by the mobile check data extraction model to calculate a fraud probability. In some embodiments, the fraud prediction model utilizes various advanced techniques, such as anomaly detection, pattern recognition, and historical data analysis, to detect inconsistencies and suspicious features in the check image data. Furthermore, the fraud prediction model may integrate additional data sources, such as user transaction history, check-writing patterns, and other relevant metadata, to determine a fraud probability.

Relatedly, as used herein, the term “machine learning model” refers to a computer algorithm or a collection of computer algorithms that automatically improve for a particular task through iterative outputs or predictions based on use of data. For example, a machine learning model can utilize one or more learning techniques to improve in accuracy and/or effectiveness. Example machine learning models include various types of neural networks, decision trees, support vector machines, linear regression models, and Bayesian networks.

Along these lines, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., acceptance probabilities or fraud probabilities) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, or a generative adversarial neural network. Upon training as described below, such a neural network may become a large language model.

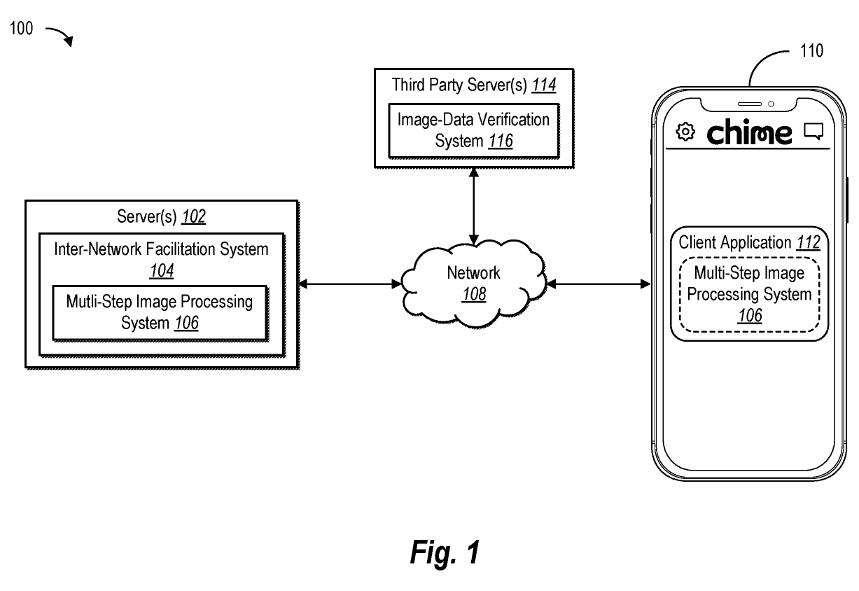

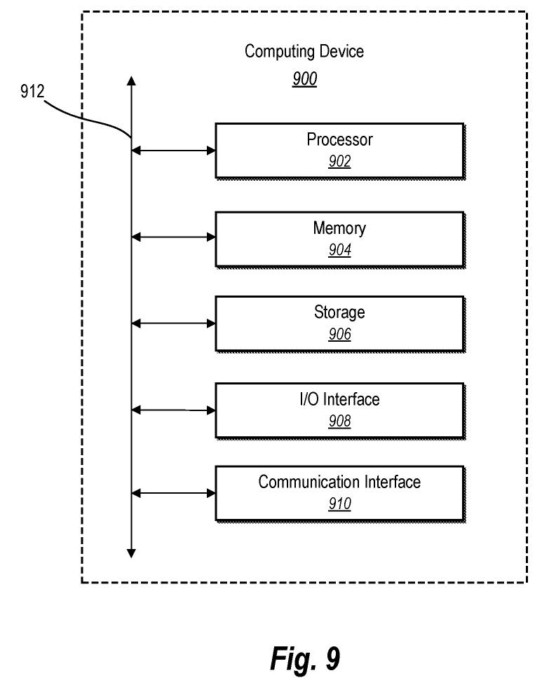

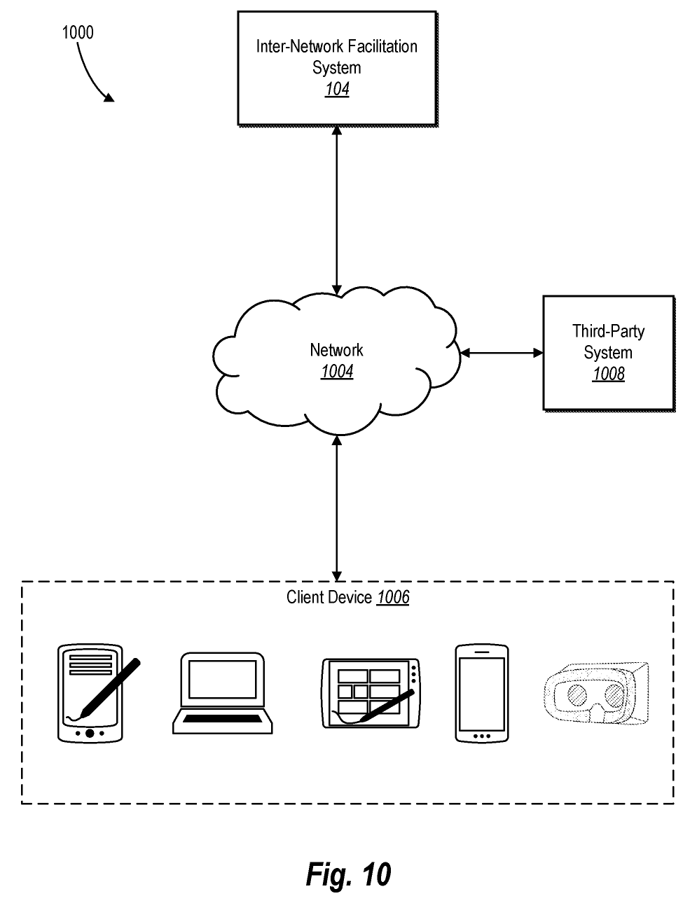

Additional detail regarding the multi-step image processing system is provided below with reference to the figures. In particular, FIG. 1 illustrates a computing system environment for implementing a multi-step image processing system 106 in accordance with one or more embodiments. As shown in FIG. 1, the environment 100 includes server(s) 102, client device 110, and third-party server(s) 114. Each of the components of the environment 100 communicate (or are configured to communicate) via a network 108, and the network 108 may be any suitable network over which computing devices can communicate. Example networks are discussed in more detail below in relation to FIGS. 9-10.

As further illustrated in FIG. 1, the environment 100 includes the server(s) 102. In some embodiments, the server(s) 102 comprise a content server and/or a data collection server. Additionally or alternatively, the server(s) 102 comprise an application server, a communication server, a web-hosting server, a social networking server, a digital content management server, a data verification server, or a financial transaction server.

Moreover, as shown in FIG. 1, the server(s) 102 implement an inter-network facilitation system 104. In one or more embodiments, the inter-network facilitation system 104 (or the multi-step image processing system 106) communicates with the client device 110 to identify accounts associated with a network transaction. More specifically, the inter-network facilitation system 104 (or the multi-step image processing system 106) can communicate with the client device 110 to request a digital image of a mobile deposit check, and indicate an approval, a denial, or a hold for the mobile deposit check.

Further, the environment 100 includes a client device 110. The client device 110 can include one of a variety of computing devices, including a smartphone, tablet, smart television, desktop computer, laptop computer, virtual reality device, augmented reality device, or other computing device as described in relation to FIGS. 9-10. Although FIG. 1 illustrates only one client device, the environment 100 can include multiple client devices. Further, in some embodiments, the client device 110 receives user input and provide information pertaining to accessing, viewing, modifying, generating, and/or initiating a network transaction to the server(s) 102, such as depositing a mobile deposit check by capturing and providing mobile check images.

Moreover, as shown, the client device 110 includes a client application 112. The client application 112 can include a web application, a native application installed on the client device 110 (e.g., a mobile application, a desktop application, a plug-in application, etc.), or a cloud-based application where part of the functionality is performed by the server(s) 102. In some embodiments, the multi-step image processing system 106 causes the client application 112 to present or display information to a user associated with the client device 110 including information relating to mobile check deposits as provided in this disclosure. In some embodiments, the client application 112 comprises the multi-step image processing system 106.

In a same or similar manner, the multi-step image processing system 106 can communicate with the third-party server(s) 114. For instance, the multi-step image processing system 106 can communicate with the third-party server(s) 114 to extract and/or verify one or more of mobile check data, restrictive endorsement data, and signature data corresponding to the client device 110. To illustrate, in certain implementations, the multi-step image processing system 106 uses the third-party server(s) 114 (e.g., GIACT® servers) to extract and verify mobile check data (utilizing image-data verification system 116) from a check image corresponding to a mobile deposit check.

In some embodiments, though not illustrated in FIG. 1, the environment 100 has a different arrangement of components and/or has a different number or set of components altogether. For example, in certain embodiments, the client device(s) communicate directly with the server(s) 102, bypassing the network 108. As another example, the environment 100 omits one or more components, such as the third-party server(s) 114. In yet another example, one or more different components implement the inter-network facilitation system 104. Likewise, in certain implementations, additional or alternative components implement the multi-step image processing system 106 to facilitate different component arrangements than illustrated in FIG. 1.

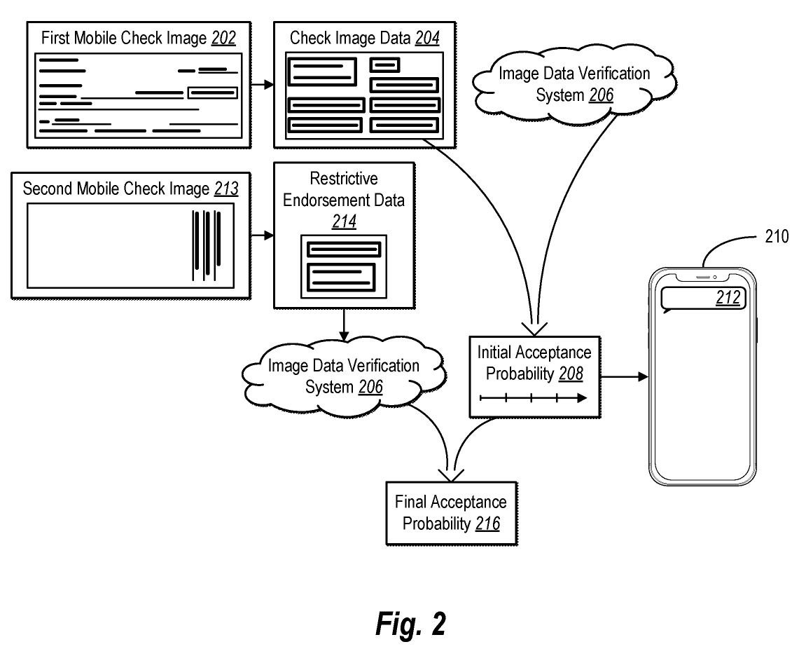

As mentioned above, the multi-step image processing system 106 can efficiently and accurately extract and analyze data from images at multiple stages. In particular, the multi-step image processing system 106 can receive and process a first mobile check image to make some preliminary determinations about receiving and processing a second mobile check image as part of depositing a mobile deposit check. FIG. 2 illustrates an overview of determining a final acceptance probability for a mobile deposit check by extracting and analyzing data at multiple stages in accordance with one or more embodiments. Additional detail regarding the various acts and processes introduced in relation to FIG. 2 is provided thereafter with reference to subsequent figures.

As shown in FIG. 2, the multi-step image processing system 106 receives a first mobile check image 202 of a mobile deposit check. For example, the multi-step image processing system 106 receives the first mobile check image 202 from the client device 210 (e.g., the client device 110). In some cases, the multi-step image processing system 106 may utilize an application on the client device 210 to provide instructions on how to capture and send the first mobile check image 202 with a camera on the client device 210. The multi-step image processing system 106 thus receives the first mobile check image 202 that includes pixels depicting the front of a mobile deposit check.

As also shown in FIG. 2, the multi-step image processing system 106 extracts check image data 204 from the first mobile check image 202. For instance, the multi-step image processing system 106 extracts the check image data 204, such as an amount, a payer name, a payee name, a date, an account number, a routing number, a financial institution from which to draw funds, and a signature of the payee. In some embodiments, the multi-step image processing system 106 employs optical character recognition models, object recognition models, and or other specialized image analysis machine learning models to detect and extract the check image data 204. In some cases, the multi-step image processing system 106 provides the first mobile check image 202 to an image data verification system 206 which performs the extraction of the check image data 204. In some cases, the image data verification system 206 refers to a verification system as described in U.S. Patent Application No. 17/653,580, titled UTILIZING A CHECK-RETURN PREDICTION MACHINE-LEARNING MODEL TO INTELLIGENTLY GENERATE CHECK-RETURN PREDICTIONS FOR NETWORK TRANSACTIONS, filed March 4, 2022, which is hereby incorporated by reference in its entirety. In some case, the check-return predictions of the incorporated application relate to, or are synonymous with, acceptance probabilities described herein.

In some embodiments, the multi-step image processing system 106 sends the extracted check image data 204 (or the first mobile check image 202) to an image data verification system 206 to be verified. For example, the image data verification system 206 by a third-party system that processes and verifies data for validating transactions. In some cases, the image data verification system 206 may cross-reference the extracted check image data 204 with a database for verification, where the database includes valid payer names, payee names, dates, account numbers, routing numbers, financial institutions, and signature data. The image data verification system 206 can also cross reference with known defunct or invalid financial institutions, account numbers, routing numbers, and other data. Additionally, the image data verification system 206 cross references with known check formats and bank information to verify the correct formatting and validity, while also utilizing advanced image processing techniques to detect security features and compare the data to internal bank records.

As further illustrated in FIG. 2, the multi-step image processing system 106 receives verified check data from the image data verification system 206. Indeed, upon the image data verification system 206 performing its analysis, the image data verification system 206 provides verified check data in the form of features indicating valid and/or invalid portions of the check image data 204. Upon receiving the verified check data from the image data verification system 206, the multi-step image processing system 106 utilizes the check image data 204 and the verified check data from the image data verification system 206 to determine an initial acceptance probability 208. For instance, the multi-step image processing system 106 utilizes an acceptance probability machine learning model to generate the initial acceptance probability 208 based on analyzing various risk factors, patterns, and trends related to the corresponding mobile deposit check.

In some embodiments, the multi-step image processing system 106, based on comparing the initial acceptance probability to one or more thresholds, provides a notification 212 to the client device 210. Indeed, in some cases, the notification 212 comprises either one or both of a notice of acceptance and a funds availability notice indicating a prediction of when the funds from the mobile deposit check will be accessible. For example, the multi-step image processing system 106 generates the notification 212 based on the initial acceptance probability 208, where the contents of the notification 212 can vary depending on the level or degree of the initial acceptance probability 208. Additional detail regarding the notification 212 is provided below.

As further illustrated in FIG. 2, the multi-step image processing system 106 receives a second mobile check image 213. In particular, in some cases, the multi-step image processing system 106 provides a consistent and uniform user experience in the mobile check deposit application, irrespective of the initial acceptance probability 208. Accordingly, in cases where the initial acceptance probability 208 does not satisfy an acceptance threshold (and the multi-step image processing system 106 therefore determines to reject or deny the mobile deposit check), the multi-step image processing system 106 nevertheless provides a user interface flow for uploading the second mobile check image 213. In some cases, the multi-step image processing system 106 receives the second mobile check image 213 without performing additional processing, while in other cases, the multi-step image processing system 106 does not even receive the second mobile check image 213 as the second upload interface is merely a façade to maintain a uniform user experience (but no transfer of the second mobile check image 213 from the client device 210 to the multi-step image processing system 106 occurs).

In one or more embodiments, the multi-step image processing system 106 determines that the initial acceptance probability 208 satisfies an acceptance threshold but does not satisfy a second, higher threshold for outright acceptance. Accordingly, the multi-step image processing system 106 determines that a restrictive endorsement is necessary for the mobile deposit check (and generates the notification 212 to indicate as much). Accordingly, the multi-step image processing system 106 receives the second mobile check image 213 and analyzes it to detect a restrictive endorsement.

In some embodiments, the multi-step image processing system 106 extracts restrictive endorsement data 214 from the second mobile check image 213. For example, similar to the process of extracting the check image data 204, the multi-step image processing system 106 extracts the restrictive endorsement data 214 by using one or more image analysis networks or machine learning models to detect and extract objects or text within the second mobile check image 213 and to identify one or more of the objects/text as restrictive endorsement data 214 (which may include a signature along with descriptor text defining a purpose or intent of the mobile deposit check). In some cases, the multi-step image processing system 106 provides the second mobile check image 213 to the image data verification system 206 for extraction and analysis.

In some embodiments, the multi-step image processing system 106 sends the restrictive endorsement data 214 (or the second mobile check image 213) to the image data verification system 206 to be verified. In particular, the image data verification system 206, as with the check image data 204, verifies the restrictive endorsement data 214 by cross checking against databases of known valid and invalid restrictive endorsement data. For example, the image data verification system 206 checks the format and the content of the restrictive endorsement data against rubrics or templates to verify that the restrictive endorsement is for a recognized purpose and/or a valid financial institution and that the restrictive endorsement data 214 includes a valid signature and/ro microprint signature data. The multi-step image processing system 106 thus receives verified restrictive endorsement data from the image data verification system 206. In some embodiments, the image data verification system 206 is part of the multi-step image processing system 106 which performs the analysis of the restrictive endorsement data 214 (and the check image data 204).

In some embodiments, the multi-step image processing system 106 identifies the type of check associated with the check image data 204 to determine whether to extract restrictive endorsement data 214. For example, the multi-step image processing system 106 may determine whether the mobile deposit check associated with the check image data 204 is a treasury check or a standard check. In some cases, the multi-step image processing system 106 requires a restrictive endorsement based on determining that the corresponding mobile deposit check is a treasury check. In other cases, the multi-step image processing system 106 may determine not to require the restrictive endorsement based on determining that the corresponding mobile deposit check is a standard check.

As further illustrated in FIG. 2, the multi-step image processing system 106 determines a final acceptance probability 216. In particular, the multi-step image processing system 106 utilizes the initial acceptance probability 208 and the verified restrictive endorsement data to determine the final acceptance probability 216. For example, the image data verification system 206 determines the final acceptance probability 216 by combining verified check data (and/or check image data 204) with verified restrictive endorsement data (and/or restrictive endorsement data 214) to input into an acceptance probability machine learning model. The acceptance probability machine learning model processes or analyzes the input data to generate the final acceptance probability 216 based on a combination of the first mobile check image 202 and the second mobile check image 213. The multi-step image processing system 106 thus processes a transaction for the mobile deposit check based on determining that the final acceptance probability 216 satisfies a final acceptance threshold.

It will be appreciated that the multi-step image processing system 106 can perform additional or alternative acts based on the initial acceptance probability 208. In some embodiments, the multi-step image processing system 106 may determine, based on the initial acceptance probability 208, to send the notification 212 comprising a notice of holding to the client device 210. In other cases, the multi-step image processing system 106 may determine, based on the initial acceptance probability 208, to send the notification 212 comprising a notice of rejection to the client device 210. Additionally, the multi-step image processing system 106 may determine not to request or require the second mobile check image 213 and to send the notification 212 comprising either a notice of acceptance (and funds availability notice), rejection, or holding to the client device 210.

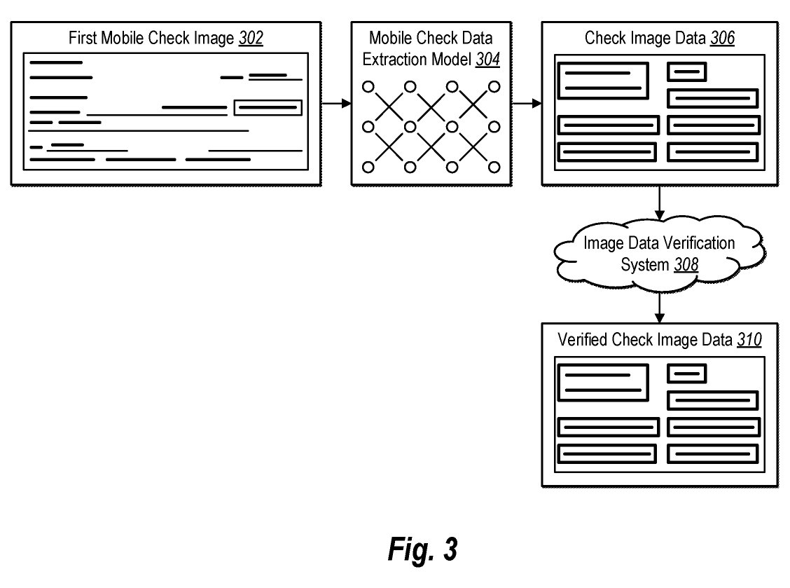

As mentioned above, the multi-step image processing system 106 can utilize a multi-step image process to extract and analyze data from mobile check image(s) to determine an initial acceptance probability. As part of this process, the multi-step image processing system 106 can verify check image data from a mobile check image. FIG. 3 illustrates the extracting and verifying mobile check data from a mobile check image in accordance with one or more embodiments.

As shown in FIG. 3, the multi-step image processing system 106 receives a first mobile check image 302. In some embodiments, the multi-step image processing system 106 utilizes a client application comprising a mobile banking application to instruct a client device to capture an image to send the first mobile check image 202 to the multi-step image processing system 106. Indeed, the multi-step image processing system 106 may provide directions to guide a client device to capture a clear, well-lit image by employing real-time feedback mechanisms to adjust a camera angle, distance, and lighting to improve image quality. The multi-step image processing system 106 can also integrate with third-party financial applications that facilitate mobile check deposits. For example, the client device may capture the mobile check image using the third-party application, which then forwards the image to the multi-step image processing system 106 for processing.

In some cases, the multi-step image processing system 106 utilizes a mobile check data extraction model 304 to extract check image data 306 from the first mobile check image 302. For example, the mobile check data extraction model 304 utilizes advanced techniques such as optical character recognition, image processing algorithms, and pattern recognition to accurately and efficiently extract check image data 306. In some embodiments, the mobile check data extraction model 304 is a machine learning model, such as a neural network, with parameters trained on sample mobile check images and corresponding ground truth check image data. The mobile check data extraction model 304 thus utilizes its learned parameters to extract the check image data 306 from objects and/or text recognized in the first mobile check image 302. To illustrate, in certain implementations, the multi-step image processing system 106 uses third-party servers and/or the mobile check data extraction model 304 to extract magnetic ink character recognition data from a first mobile check image 302 corresponding to a mobile check deposit.

As further illustrated in FIG. 3, in one or more embodiments, the multi-step image processing system 106 provides the check image data 306 (or the first mobile check image 302) to an image data verification system 308. Upon receiving the check image data 306, the image data verification system 308 generates the verified check image data 310. To elaborate, the image data verification system 308 can cross-reference the extracted check image data 204 with a database of known check formats and bank information and, by comparing the check image data 204 against standardized check formats and known valid/invalid data, verify that the routing number, account number, and other elements of the check image data 306 are correctly formatted and valid.

In some cases, the image data verification system 308 utilizes image processing techniques to verify the presence of security features commonly found on checks, such as watermarks, microprinting, and holograms. Additionally, the image data verification system 308 may compare the extracted check image data 306 to internal bank records by confirming that the account number is active, the financial institution is properly accredited, the check number has not been previously deposited, and the account has sufficient funds to cover the check amount. The multi-step image processing system 106 thus generates the verified check image data 310. In some embodiments, the image data verification system 308 is operated by a third-party system, while in other embodiments the image data verification system 308 is part of the multi-step image processing system 106 and/or the inter-network facilitation system 104.

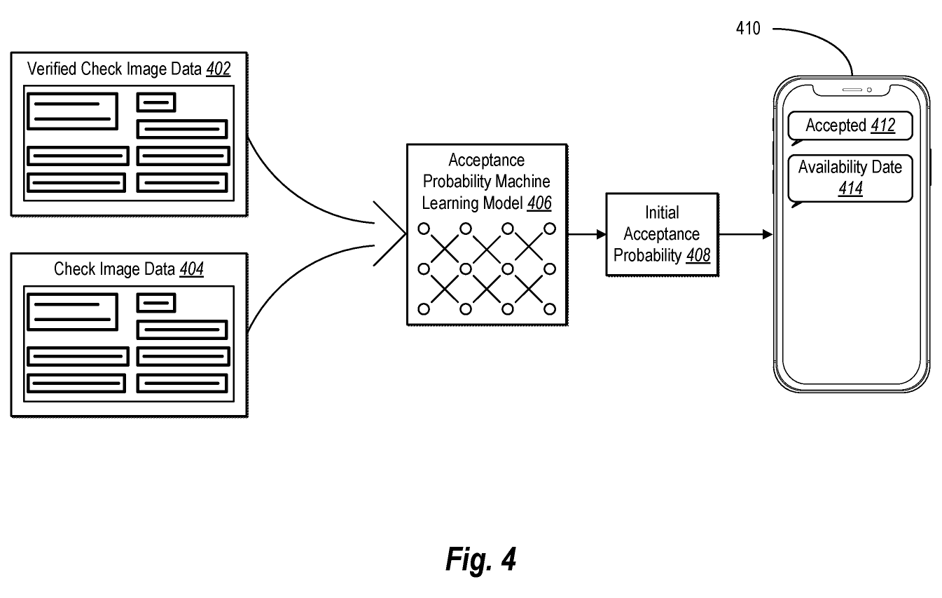

As mentioned above, the multi-step image processing system 106 can generate an initial acceptance probability based on verified check data extracted from a first mobile check image. In addition, the multi-step image processing system 106 can generate and provide one or more notifications to a client device regarding the initial acceptance probability. FIG. 4 illustrates an example diagram for generating an initial acceptance probability and a corresponding notification in accordance with one or more embodiments.

As illustrated in FIG. 4, in some embodiments, the multi-step image processing system 106 determines or accesses verified check data 402 and/or check image data 404. As described above, the multi-step image processing system 106 generates or extracts the check image data 404 and/or the verified check data 402 from a first mobile check image depicting a first (e.g., front) side of a mobile deposit check. In addition, the multi-step image processing system 106 inputs the check image data 404 and the verified check data 402 into an acceptance probability machine learning model 406.

Upon receiving the check image data 404 and the verified check data 402, the acceptance probability machine learning model 406 determines the initial acceptance probability 408. Specifically, the acceptance probability machine learning model 406 can determine the initial acceptance probability 208 based on various factors from the input data, such as check amount, account history associated with the payer and payee, and the presence of security features. For example, by evaluating patterns and trends in the account holder's previous deposits, the multi-step image processing system 106 can determine if the mobile deposit check aligns with typical behavior or exhibits unusual characteristics that might indicate fraud.

Indeed, the multi-step image processing system 106 can train the acceptance probability machine learning model 406 on historical mobile check deposit behavior and/or on historical mobile check deposit data. Accordingly, the acceptance probability machine learning model 406 can analyze the verified check data 402 and the check image data 404 to compare with the historical data (and/or based on parameters learned from the historical data) to detect anomalies that impact acceptance probabilities.

Based on the determining that the initial acceptance probability 408, the multi-step image processing system 106 further generates one or more notifications to provide to a client device 410. In particular, the multi-step image processing system 106 generates a notification 412 indicating acceptance of a mobile deposit check based on determining that the initial acceptance probability 408 satisfies an acceptance threshold. In addition, the multi-step image processing system 106 generates a notification 414 that indicates a predicted availability date of the funds indicated in the check image data 404. In some cases, the multi-step image processing system 106 may not generate notifications if the initial acceptance probability 408 does not satisfy an acceptance threshold, or the multi-step image processing system 106 may generate different notifications (e.g., a denial/rejection notification or a notification requesting a restrictive endorsement on an additional image). By generating notifications based on processing only a first mobile check image, the multi-step image processing system 106 improves speed (by reducing latency in waiting for the flow to progress) and security over prior systems that require processing multiple images together.

It will be appreciated that the multi-step image processing system 106 can perform additional or alternative acts based on the initial acceptance probability 408. To elaborate, based on determining that the initial acceptance probability 408 satisfies certain thresholds, the multi-step image processing system 106 may provide a notification of rejection or holding to the client device 410. Additionally, the multi-step image processing system 106 may determine, based on the acceptance probability satisfying certain thresholds, to also provide a notification comprising a request for a second mobile check image from the client device 410. In some cases, based on the acceptance probability satisfying certain thresholds, the multi-step image processing system 106 also provides a notification requiring a restrictive endorsement to be included in the second mobile check image.

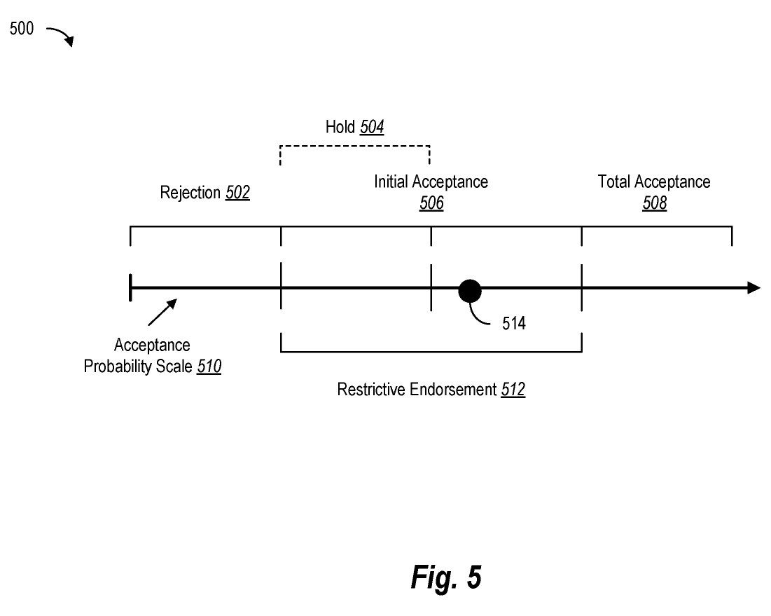

As noted above, in certain embodiments, the multi-step image processing system 106 compares an initial acceptance probability to one or more thresholds. In particular, the multi-step image processing system 106 compares the initial acceptance probability with multiple thresholds to determine which notifications to generate and/or to determine how to treat a mobile deposit check. FIG. 5 illustrates an example diagram of comparing an initial acceptance probability with various thresholds or ranges in accordance with one or more embodiments.

As illustrated in the diagram 500 of FIG. 5, the multi-step image processing system 106 determines an initial acceptance probability 514 for a first mobile check image. The multi-step image processing system 106 further compares the initial acceptance probability with multiple thresholds and/or ranges in an acceptance probability scale 510 (or an acceptance probability spectrum). For instance, the multi-step image processing system 106 generates or accesses the acceptance probability scale 510 as the basis for determining treatment of mobile deposit checks (e.g., based on a first mobile check image).

Within the acceptance probability scale 510, the multi-step image processing system 106 determines a rejection range 502 that spans from a 0% acceptance probability up to a minimum acceptance probability threshold. The multi-step image processing system 106 also determines an initial acceptance range 506 that spans from the minimum acceptance probability threshold up to 100% acceptance probability (e.g., everywhere beyond the rejection range 502). Within the initial acceptance range 506, the multi-step image processing system 106 further determines additional ranges, such as a total acceptance range 508 that spans from a total/outright acceptance threshold and beyond. The multi-step image processing system 106 further determines a restrictive endorsement range 512 that spans from an initial acceptance threshold up to a total/outright acceptance threshold. Additionally, in some embodiments, the multi-step image processing system 106 determines a hold range 504 that spans from the initial acceptance probability threshold up to a hold threshold.

Depending on where an initial acceptance probability falls within the acceptance probability scale 510, the multi-step image processing system 106 generates different notifications to provide to a client device and/or treats a mobile deposit check different. As shown, the multi-step image processing system 106 determines an initial acceptance probability 514 within the initial acceptance range 506 (or satisfying an initial acceptance threshold). More granularly, the multi-step image processing system 106 determines that the initial acceptance probability is above the hold range 504 (or the hold threshold), below the total acceptance range 508 (or the total/outright acceptance threshold), and within the restrictive endorsement range 512. Accordingly, the multi-step image processing system 106 determines that a restrictive endorsement is necessary for processing the mobile deposit check. The multi-step image processing system 106 thus generates a notification requesting a second mobile check image, prompting inclusion of a restrictive endorsement within the image.

In one or more embodiments, the multi-step image processing system 106 determines or generates a deferred restrictive endorsement for a mobile deposit check. For example, based on the initial acceptance probability 514, the multi-step image processing system 106 determines to require or request a restrictive endorsement for the mobile deposit check. Because no such restrictive endorsement has been provided to this point, the multi-step image processing system 106 thus generates a deferred restrictive endorsement that prompts or causes providing a request for a restrictive endorsement as part of a second mobile check image. The multi-step image processing system 106 thus generates a deferred restrictive endorsement in the sense that the restrictive endorsement request is responsive to the initial acceptance probability 514 and that the restrictive endorsement is processed later as part of a follow-up mobile check image based on the first mobile check image.

In some embodiments, if an initial acceptance probability for a mobile deposit check is below the rejection range 502 (or below the acceptance threshold), the multi-step image processing system 106 provides a notification of rejection to a client device corresponding to the mobile deposit check. In other embodiments, the multi-step image processing system 106 provides no rejection notification and instead proceeds to prompt capture of a second mobile check image but without receiving and/or processing the second image. In these embodiments, the multi-step image processing system 106 generates and provides a rejection notification only after completing the interface flow of providing the second mobile check image.

Alternatively, if the multi-step image processing system 106 determines that an initial acceptance probability for a mobile deposit check is outside the rejection range 502 (or satisfies the rejection threshold) and is within hold range 504, the multi-step image processing system 106 provides a notification of holding the mobile deposit check (e.g., designating for processing after expiration of a threshold time period). In some cases, if the multi-step image processing system 106 determines that an initial acceptance probability of a mobile deposit check is outside the hold range 504 (or satisfies the hold threshold) and is below the total acceptance range 508, the multi-step image processing system 106 provides a notice of initial acceptance to the client device corresponding to the mobile deposit check while also prompting inclusion of a second mobile deposit check.

In some embodiments, if the multi-step image processing system 106 determines that an initial acceptance probability of a mobile deposit check satisfies the total acceptance threshold (e.g., is within the total acceptance range 508), the multi-step image processing system 106 provides a notification of acceptance to a client device corresponding to the mobile deposit check without requesting a restrictive endorsement. The multi-step image processing system 106 may still prompt and receive a second mobile check image for such a case, but the multi-step image processing system 106 may not necessarily process the second mobile check image for approval or data extraction (merely storing the image together with the first image for the mobile deposit check).

In some embodiments, the multi-step image processing system 106 similarly compares a final acceptance probability to thresholds along the acceptance probability scale 510. For example, the multi-step image processing system 106 determines whether to accept, reject, or hold a mobile deposit check associated with the final acceptance probability. To elaborate, if a final acceptance probability for a mobile deposit check is below the rejection threshold (or the rejection range 502), the multi-step image processing system 106 provides a notification of rejection to a client device corresponding to the mobile deposit check. In some embodiments, if a final acceptance probability of a mobile deposit check satisfies the total acceptance threshold (or is within the total acceptance range 508), the multi-step image processing system 106 provides a notification of acceptance to a client device corresponding to the mobile deposit check. Alternatively, if a final acceptance probability for a mobile deposit check surpasses the rejection range 502 (or satisfies an acceptance threshold) but does not surpass the hold range 504, the multi-step image processing system 106 provides a notification of holding the mobile deposit check.

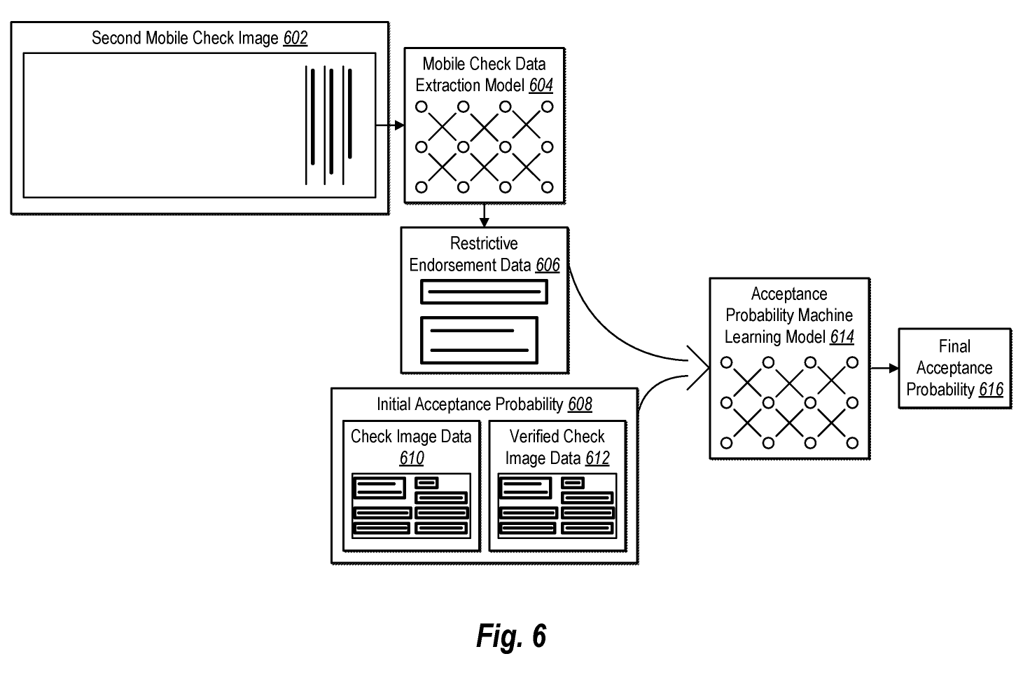

As discussed above, the multi-step image processing system 106 can efficiently and accurately extract and analyze data from mobile check images at different stages to determine a final acceptance probability. In particular, the multi-step image processing system 106 can analyze a second mobile check image to extract data which contributes to a final acceptance probability for a mobile deposit check. FIG. 6 illustrates extracting and analyzing data from a second mobile check image to determine a final acceptance probability in accordance with one or more embodiments.

As shown in FIG. 6, the multi-step image processing system 106 receives a second mobile check image 602. In some embodiments, the multi-step image processing system 106 receives the second mobile check image 602 from a client device as described above in relation to the multi-step image processing system 106 receiving a first mobile check image. For example, the multi-step image processing system 106 receives the second mobile check image 602 as part of an interface flow for processing a mobile deposit check. In some cases, the multi-step image processing system 106 receives the second mobile check image 602 after processing the first mobile check image. Indeed, the multi-step image processing system 106 can provide user interfaces for capturing and uploading the second mobile check image 602 as the multi-step image processing system 106 simultaneously processes the first mobile check image for an initial acceptance probability. Thus, the multi-step image processing system 106 continues progressing the client device through the flow with less idle time than prior systems, all while continuing to extract, validate, and generate probabilities from the first mobile check image.

In some embodiments, the multi-step image processing system 106 utilizes a mobile check data extraction model 604 to process the second mobile check image 602. For example, the mobile check data extraction model 604 extracts restrictive endorsement data 606 from the second mobile check image 602. In some embodiments, the mobile check data extraction model 604 extracts the restrictive endorsement data 606 from the second mobile check image 602 uses optical character recognition, object recognition, and other techniques. In some cases, extracting the restrictive endorsement data 606 includes identifying and extracting specific restrictive endorsement markings or descriptions, signatures, stamps, or other security features unique to the back of mobile deposit checks.

In some cases, the multi-step image processing system 106 sends the restrictive endorsement data 606 to an image data verification system, which provides the verified restrictive endorsement data in return. For example, as described, the image data verification system verifies or validates the restrictive endorsement data 606 by using pattern recognition, comparing against known signatures, and/or verifying a restrictive endorsement against known valid restrictive endorsement language. In one or more embodiments, the multi-step image processing system 106 further utilizes an acceptance probability machine learning model 614 (e.g., the same model as for the first mobile check image or a separate model) to process the restrictive endorsement data 606 and/or verified restrictive endorsement data. The multi-step image processing system 106 thus utilizes the acceptance probability machine learning model 614 to generate a final acceptance probability 616.

In some embodiments, the multi-step image processing system 106 determines the final acceptance probability 616 from the restrictive endorsement data 606 (including verified data) as well as an initial acceptance probability 608. Indeed, as described above, the multi-step image processing system 106 utilizes check image data 610 and verified check image data 612 to determine the initial acceptance probability 608. Specifically, the acceptance probability machine learning model 614 thus utilizes initial acceptance probability 608 (and/or the check image data 610 and the verified check image data 612) to determine the final acceptance probability 616. In some cases, the acceptance probability machine learning model 614 utilizes the initial acceptance probability 608, the check image data 610, the verified check image data 612, and the restrictive endorsement data 606 to determine the final acceptance probability 616.

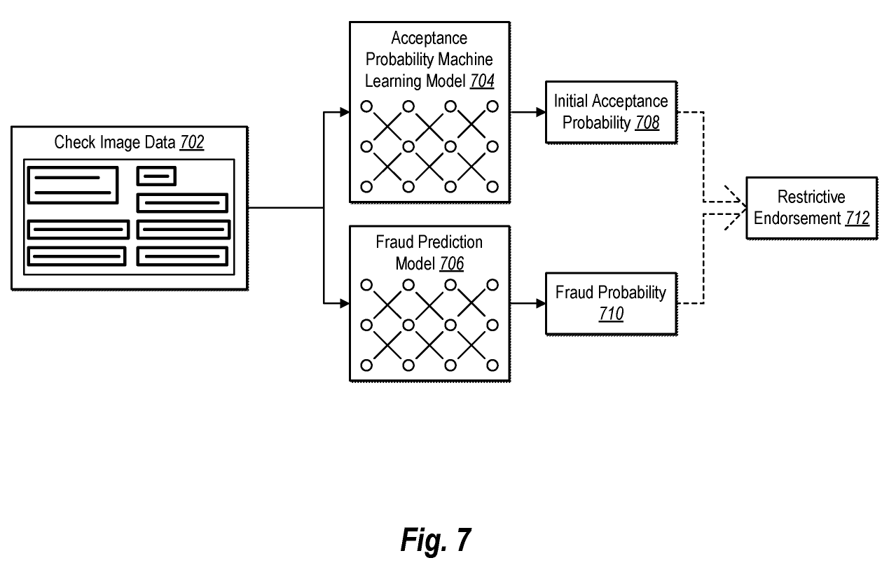

As mentioned above, in certain embodiments, the multi-step image processing system 106 determines whether to provide a requirement for a restrictive endorsement as part of a mobile check image. In particular, the multi-step image processing system 106 can determine a fraud probability in addition to determining an initial acceptance probability based on a first mobile check image. FIG. 7 illustrates an example diagram for determining whether to request a restrictive endorsement based on a fraud probability and an acceptance probability in accordance with one or more embodiments.

As illustrated in FIG. 7, the multi-step image processing system 106 provides check image data 702 to an acceptance probability machine learning model 704 and to a fraud prediction model 706. As described above, upon receiving the check image data 702, the acceptance probability machine learning model 704 determines an initial acceptance probability 708.

In some embodiments, the multi-step image processing system 106 concurrently utilizes a fraud prediction model 706 to process the check image data 702 (and/or verified check image data). Upon receiving the check image data 702, the fraud prediction model 706 determines a fraud probability. For example, the fraud prediction model 706 (e.g., a neural network trained to recognize fraudulent data based on sample valid data and sample fraudulent data) may analyze patterns and indicators that might suggest fraudulent activity including assessing anomalies in the check image data 702, such as unusual check numbers, mismatched payee information, discrepancies in format and appearance, invalid routing/account numbers, and/or defunct financial institution names.

The multi-step image processing system 106 may then determine whether to request a restrictive endorsement 712 based on a combination of the initial acceptance probability 708 and the fraud probability 710. Specifically, the multi-step image processing system 106 may request the restrictive endorsement 712 based on determining that the initial acceptance probability 708 satisfies one or more thresholds (as described above in relation to FIG. 5) and/or that the fraud probability 710 satisfies one or more thresholds.

In some embodiments, the multi-step image processing system 106 compares the fraud probability 710 to one or more fraud thresholds. To elaborate, the multi-step image processing system 106 may determine that the fraud probability 710 satisfies a fraud threshold, thus indicating that at least a portion of the check image data is fraudulent. In some cases, the multi-step image processing system 106 determines that the fraud probability 710 satisfies a first, lower fraud threshold but does not satisfy a second, higher threshold. Accordingly, the multi-step image processing system 106 further considers the initial acceptance probability 708 to determine whether or not to require the restrictive endorsement 712. Indeed, if the initial acceptance probability 708 is high enough to satisfy an acceptance threshold, the multi-step image processing system 106 may decide to accept the mobile deposit check even if the fraud probability 710 satisfies a fraud threshold. In such cases, the multi-step image processing system 106 may determine to require the restrictive endorsement 712 as an added security measure.

Conversely, the multi-step image processing system 106 may determine to reject a mobile deposit check—and thus determine not to require the restrictive endorsement 712—based on determining that the initial acceptance probability 708 does not satisfy an acceptance probability and/or that the fraud probability 710 satisfies a higher fraud probability threshold indicating a higher degree of confidence that the check image data 702 is fraudulent. In some cases, the multi-step image processing system 106 may determine not to require the restrictive endorsement 712 based on determining that the initial acceptance probability 708 satisfies a higher acceptance thresholds and/or that the fraud probability 710 does not satisfy a fraud threshold.

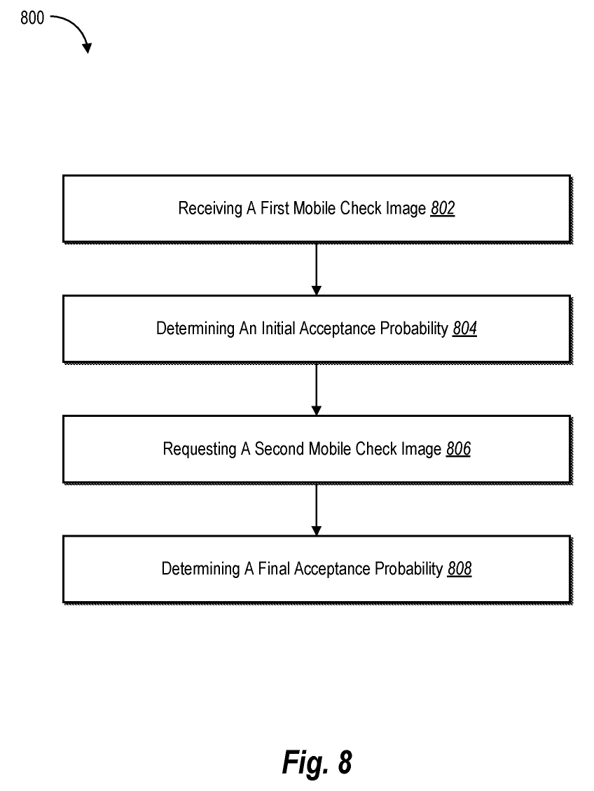

FIGS. 1-7, the corresponding text, and the examples provide several different systems, methods, techniques, components, and/or devices for using a multi-step approach to determining acceptance probabilities for mobile deposit checks in accordance with one or more embodiments. In addition to the above description, one or more embodiments can also be described in terms of flowcharts including acts for accomplishing a particular result. For example, FIG. 8 illustrates a flowchart of a series of acts in accordance with one or more embodiments.

The multi-step image processing system 106 may perform one or more acts in addition to or alternatively to one or more acts described in conjunction with other figures. While FIG. 8 illustrates acts according to one embodiment, alternative embodiments may omit, add to, reorder, and/or modify any of the acts shown in FIG. 8. The acts of FIG. 8 can be performed as part of a method. Alternatively, a non-transitory computer-readable medium can comprise instructions that, when executed by one or more processors, cause a computing device to perform the acts of FIG. 8. In some embodiments, a system can perform the acts of FIG. 8. Additionally, the acts described herein may be repeated or performed in parallel with one another or in parallel with different instances of the same or other similar acts.

As shown in FIG. 8, the series of acts 800 includes an act 802 of receiving a first mobile check image. In some embodiments, the act 802 involves receiving, from a client device, a first mobile check image depicting the front of a mobile deposit check.

In addition, the series of acts 800 includes an act 804 of determining an initial acceptance probability. In some embodiments, the act 804 involves utilizing an acceptance probability machine learning model to analyze check image data extracted from a first mobile check image utilizing a mobile check data extraction model.

The series of acts 800 further includes an act 806 of requesting a second mobile check image. In some embodiments, the act 806 involves providing a notification to a client device. Specifically, the notification may comprise a message requiring or requesting the client device to provide a second mobile check image. In some cases, the notification further comprises a notice of acceptance, withdrawal, or holding. Additionally, the notification may further comprise a requirement or a request to include a restrictive endorsement in the second mobile check image.

Additionally, the series of acts 800 includes an act 808 of determining a final acceptance probability. In some embodiments, the act 808 involves analyzing verified restrictive endorsement data and an initial acceptance probability. In some embodiments, the multi-step image processing system 106 only determines to determine a final acceptance probability based on comparing the initial acceptance probability to one or more thresholds.

The series of acts 800 can include an act of providing a notification for the mobile deposit check based on determining that the initial acceptance probability satisfies an acceptance threshold. In addition, the series of acts 800 can include an act of determining, based on the first mobile check image, that the initial acceptance probability satisfies an acceptance threshold and does not satisfy a second acceptance threshold. Further, the series of acts 800 can include an act of based on determining that the initial acceptance probability satisfies the acceptance threshold and does not satisfy the second acceptance threshold, generating a restrictive endorsement notification instructing the client device to include a restrictive endorsement in the second mobile check image.

In some embodiments, the series of acts 800 can include an act of determining the final acceptance probability based on the restrictive endorsement in the second mobile check image. The series of acts 800 can also include an act of determining that the initial acceptance probability does not satisfy a hold threshold and an act of holding the mobile deposit check based on determining that the initial acceptance probability does not satisfy the hold threshold.

In some cases, the series of acts 800 can include an act of providing check image data extracted from the first mobile deposit check to an image data verification system. Additionally, the series of acts 800 can include an act of receiving, from the image data verification system, verified check data for the mobile deposit check and an act of generating the initial acceptance probability utilizing an acceptance probability machine learning model that processes the verified check data. The series of acts 800 can further include an act of generating a deferred restrictive endorsement for the mobile deposit check by requesting a restrictive endorsement for the second mobile check image in response to determining the initial acceptance probability.

It is understood that the outlined acts in the series of acts 800 are only provided as examples, and some of the acts may be optional, combined into fewer acts, or expanded into additional acts without detracting from the essence of the disclosed embodiments. Additionally, the series of acts 800 described herein may be repeated or performed in parallel with one another or in parallel with different instances of the same or similar acts. As an example of an additional act not shown in FIG. 8, act(s) in the series of acts 800 may include an act of determining, based on analyzing a fraud probability and an initial acceptance probability, whether to require a restrictive endorsement in the second mobile check image.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates, in block diagram form, an exemplary computing device 900 (e.g., the server(s) 102, the client device 110, and/or the third-party server(s) 114) that may be configured to perform one or more of the processes described above. As shown by FIG. 9, the computing device can comprise a processor 902, memory 904, a storage device 906, an I/O interface 908, and a communication interface 910. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, storage device 906 can comprise a non-transitory storage medium described above. The storage device 906 may include a hard disk drive (“HDD”), flash memory, a Universal Serial Bus (“USB”) drive or a combination of these or other storage devices.

The computing device 900 also includes one or more input or output interface 908 (or “I/O interface 908”), which are provided to allow a user (e.g., requester or provider) to provide input to (such as user strokes), receive output from, and otherwise transfer data to and from the computing device 900. The I/O interface 908 may include a mouse, keypad or a keyboard, a touch screen, camera, optical scanner, network interface, modem, other known I/O devices or a combination of such I/O interface 908. The touch screen may be activated with a stylus or a finger.

The I/O interface 908 may include one or more devices for presenting output to a user, including, but not limited to, a graphics engine, a display (e.g., a display screen), one or more output providers (e.g., display providers), one or more audio speakers, and one or more audio providers. In certain embodiments, interface 908 is configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 can provide one or more interfaces for communication (such as, for example, packet-based communication) between the computing device and one or more other computing devices 900 or one or more networks. As an example, and not by way of limitation, communication interface 910 may include a network interface controller (“NIC”) or network adapter for communicating with an Ethernet or other wire-based network or a wireless NIC (“WNIC”) or wireless adapter for communicating with a wireless network, such as a WI-FI. The computing device 900 can further include a bus 912. The bus 912 can comprise hardware, software, or both that connects components of computing device 900 to each other.

FIG. 10 illustrates an example network environment 1000 of the inter-network facilitation system 104. The network environment 1000 includes a client device 1006 (e.g., client device 110), an inter-network facilitation system 104, and a third-party system 1008 connected to each other by a network 1004. Although FIG. 10 illustrates a particular arrangement of the client device 1006, the inter-network facilitation system 104, the third-party system 1008, and the network 1004, this disclosure contemplates any suitable arrangement of client device 1006, the inter-network facilitation system 104, the third-party system 1008, and the network 1004. As an example, and not by way of limitation, two or more of client device 1006, the inter-network facilitation system 104, and the third-party system 1008 communicate directly, bypassing network 1004. As another example, two or more of client device 1006, the inter-network facilitation system 104, and the third-party system 1008 may be physically or logically co-located with each other in whole or in part.

Moreover, although FIG. 10 illustrates a particular number of client devices 1006, inter-network facilitation systems 104, third-party systems 1008, and networks 1004, this disclosure contemplates any suitable number of client devices 1006, inter-network facilitation system 104, third-party systems 1008, and networks 1004. As an example, and not by way of limitation, network environment 1000 may include multiple client devices 1006, inter-network facilitation system 104, third-party systems 1008, and/or networks 1004.

This disclosure contemplates any suitable network 1004. As an example, and not by way of limitation, one or more portions of network 1004 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1004 may include one or more networks.

Links may connect client device 1006, multi-step image processing system 106, and third-party system 1008 to network 1004 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1000. One or more first links may differ in one or more respects from one or more second links.

In particular embodiments, the client device 1006 may be an electronic device including hardware, software, or embedded logic components or a combination of two or more such components and capable of carrying out the appropriate functionalities implemented or supported by client device 1006. As an example, and not by way of limitation, a client device 1006 may include any of the computing devices discussed above in relation to FIG. 9. A client device 1006 may enable a network user at the client device 1006 to access network 1004. A client device 1006 may enable its user to communicate with other users at other client devices 1006.

In particular embodiments, the client device 1006 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1006 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1006 one or more Hyper Text Markup Language (“HTML”) files responsive to the HTTP request. The client device 1006 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 1004) to link the third-party-system 1008. For example, the inter-network facilitation system 104 may receive authentication credentials from a user to link a third-party system 1008 such as an online bank account, credit account, debit account, or other financial account to a user account within the inter-network facilitation system 104. The inter-network facilitation system 104 can subsequently communicate with the third-party system 1008 to detect or identify balances, transactions, withdrawal, transfers, deposits, credits, debits, or other transaction types associated with the third-party system 1008. The inter-network facilitation system 104 can further provide the aforementioned or other financial information associated with the third-party system 1008 for display via the client device 1006. In some cases, the inter-network facilitation system 104 links more than one third-party system 1008, receiving account information for accounts associated with each respective third-party system 1008 and performing operations or transactions between the different systems via authorized network connections.

In particular embodiments, the inter-network facilitation system 104 may interface between an online banking system and a credit processing system via the network 1004. For example, the inter-network facilitation system 104 can provide access to a bank account of a third-party system 1008 and linked to a user account within the inter-network facilitation system 104. Indeed, the inter-network facilitation system 104 can facilitate access to, and transactions to and from, the bank account of the third-party system 1008 via a client application of the inter-network facilitation system 104 on the client device 1006. The inter-network facilitation system 104 can also communicate with a credit processing system, an ATM system, and/or other financial systems (e.g., via the network 1004) to authorize and process credit charges to a credit account, perform ATM transactions, perform transfers (or other transactions) across accounts of different third-party systems 1008, and to present corresponding information via the client device 1006.

In particular embodiments, the inter-network facilitation system 104 includes a model for approving or denying transactions. For example, the inter-network facilitation system 104 includes an acceptance probability machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 1008), the inter-network facilitation system 104 can utilize the acceptance approval machine learning model to generate a prediction (e.g., a percentage likelihood) of approval or denial of a transaction (e.g., a deposit, a withdrawal, a transfer, or a purchase) across one or more networked systems.

The inter-network facilitation system 104 may be accessed by the other components of network environment 1000 either directly or via network 1004. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1006, or an inter-network facilitation system 104 to manage, retrieve, modify, add, or delete, the information stored in data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 1004.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 1006. An action logger may be used to receive communications from a web server about a user’s actions on or off the inter-network facilitation system 104. In conjunction with the action log, a third-party-content-object log may be maintained of user exposures to third-party-content objects. A notification controller may provide information regarding content objects to a client device 1006. Information may be pushed to a client device 1006 as notifications, or information may be pulled from client device 1006 responsive to a request received from client device 1006. Authorization servers may be used to enforce one or more privacy settings of the users of the inter-network facilitation system 104. A privacy setting of a user determines how particular information associated with a user can be shared. The authorization server may allow users to opt into or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 1006 associated with users.

In addition, the third-party system 1008 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 1004. A third-party system 1008 can communicate with the inter-network facilitation system 104 to provide financial information pertaining to balances, transactions, and other information, whereupon the inter-network facilitation system 104 can provide corresponding information for display via the client device 1006. In particular embodiments, a third-party system 1008 communicates with the inter-network facilitation system 104 to update account balances, transaction histories, credit usage, and other internal information of the inter-network facilitation system 104 and/or the third-party system 1008 based on user interaction with the inter-network facilitation system 104 (e.g., via the client device 1006). Indeed, the inter-network facilitation system 104 can synchronize information across one or more third-party systems 1008 to reflect accurate account information (e.g., balances, transactions, etc.) across one or more networked systems, including instances where a transaction (e.g., a deposit) from one third-party system 1008 affects another third-party system 1008.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method, comprising:
receiving, from a client device, a first mobile check image portraying a first side of a mobile deposit check;
determining, based on the first mobile check image, an initial acceptance probability for the mobile deposit check;
requesting, based on determining the initial acceptance probability, a second mobile check image from the client device portraying a second side of the mobile deposit check; and
determining, based on the first mobile check image and the second mobile check image, a final acceptance probability for the mobile deposit check.

2. The computer-implemented method of claim 1, further comprising providing a notification for the mobile deposit check based on determining that the initial acceptance probability satisfies an acceptance threshold.

3. The computer-implemented method of claim 1, further comprising:
determining, based on the first mobile check image, that the initial acceptance probability satisfies an acceptance threshold and does not satisfy a second acceptance threshold; and
based on determining that the initial acceptance probability satisfies the acceptance threshold and does not satisfy the second acceptance threshold, generating a restrictive endorsement notification instructing the client device to include a restrictive endorsement in the second mobile check image.

4. The computer-implemented method of claim 3, further comprising determining the final acceptance probability based on the restrictive endorsement in the second mobile check image.

5. The computer-implemented method of claim 1, further comprising:
determining that the initial acceptance probability does not satisfy a hold threshold; and
holding the mobile deposit check based on determining that the initial acceptance probability does not satisfy the hold threshold.

6. The computer-implemented method of claim 1, further comprising:
providing check image data extracted from the first mobile check image to an image data verification system;
receiving, from the image data verification system, verified check data for the mobile deposit check; and
generating the initial acceptance probability utilizing an acceptance probability machine learning model that processes the verified check data.

7. The computer-implemented method of claim 1, further comprising generating a deferred restrictive endorsement for the mobile deposit check by requesting a restrictive endorsement for the second mobile check image in response to determining the initial acceptance probability.

8. A non-transitory computer-readable medium comprising instructions that, when executed by at least one processor, cause a computer system to:
receive, from a client device, a first mobile check image portraying a first side of a mobile deposit check;
determine, based on the first mobile check image, an initial acceptance probability for the mobile deposit check;
request, based on determining the initial acceptance probability, a second mobile check image from the client device portraying a second side of the mobile deposit check; and
determine, based on the first mobile check image and the second mobile check image, a final acceptance probability for the mobile deposit check.

9. The non-transitory computer-readable medium of claim 8, further comprising instructions that, when executed by the at least one processor, cause the computer system to provide a notification for the mobile deposit check based on determining that the initial acceptance probability satisfies an acceptance threshold.

10. The non-transitory computer-readable medium of claim 8, further comprising instructions that, when executed by the at least one processor, cause the computer system to:
determine, based on the first mobile check image, that the initial acceptance probability satisfies an acceptance threshold and does not satisfy a second acceptance threshold; and
based on determining that the initial acceptance probability satisfies the acceptance threshold and does not satisfy the second acceptance threshold, generate a restrictive endorsement notification instructing the client device to include a restrictive endorsement in the second mobile check image.

11. The non-transitory computer-readable medium of claim 10, further comprising instructions that, when executed by the at least one processor, cause the computer system to determine the final acceptance probability based on the restrictive endorsement in the second mobile check image.

12. The non-transitory computer-readable medium of claim 8, further comprising instructions that, when executed by the at least one processor, cause the computer system to:
determine that the initial acceptance probability does not satisfy a hold threshold; and
hold the mobile deposit check based on determining that the initial acceptance probability does not satisfy the hold threshold.

13. The non-transitory computer-readable medium of claim 8, further comprising instructions that, when executed by the at least one processor, cause the computer system to:
provide check image data extracted from the first mobile check image to an image data verification system;
receive, from the image data verification system, verified check data for the mobile deposit check; and
generate the initial acceptance probability utilizing an acceptance probability machine learning model that processes the verified check data.

14. The non-transitory computer-readable medium of claim 8, further comprising instructions that, when executed by the at least one processor, cause the computer system to generate a deferred restrictive endorsement for the mobile deposit check by requesting a restrictive endorsement for the second mobile check image in response to determining the initial acceptance probability.

15. A system comprising:
at least one processor; and
a non-transitory computer readable medium comprising instructions that, when executed by the at least one processor, cause the system to:
receive, from a client device, a first mobile check image portraying a first side of a mobile deposit check;
determine, based on the first mobile check image, an initial acceptance probability for the mobile deposit check;
request, based on determining the initial acceptance probability, a second mobile check image from the client device portraying a second side of the mobile deposit check; and
determine, based on the first mobile check image and the second mobile check image, a final acceptance probability for the mobile deposit check.

16. The system of claim 15, further comprising instructions that, when executed by the at least one processor, cause the system to provide a notification for the mobile deposit check based on determining that the initial acceptance probability satisfies an acceptance threshold.

17. The system of claim 15, further comprising instructions that, when executed by the at least one processor, cause the system to:
determine, based on the first mobile check image, that the initial acceptance probability satisfies an acceptance threshold and does not satisfy a second acceptance threshold; and
based on determining that the initial acceptance probability satisfies the acceptance threshold and does not satisfy the second acceptance threshold, generate a restrictive endorsement notification instructing the client device to include a restrictive endorsement in the second mobile check image.

18. The system of claim 17, further comprising instructions that, when executed by the at least one processor, cause the system to determine the final acceptance probability based on the restrictive endorsement in the second mobile check image.

19. The system of claim 15, further comprising instructions that, when executed by the at least one processor, cause the system to:
determine that the initial acceptance probability does not satisfy a hold threshold; and
hold the mobile deposit check based on determining that the initial acceptance probability does not satisfy the hold threshold.

20. The system of claim 15, further comprising instructions that, when executed by the at least one processor, cause the system to:
provide check image data extracted from the first mobile check image to an image data verification system;
receive, from the image data verification system, verified check data for the mobile deposit check; and
generate the initial acceptance probability utilizing an acceptance probability machine learning model that processes the verified check data.
